(19) United States
(12) Patent Application Publication
(10) Pub. No.: US 2022/0120885 A1
(43) Pub. Date: Apr. 21, 2022

(54) ELECTRONIC DEVICE FOR RECOGNIZING OBJECT, AND OPERATING METHOD THEREOF

(71) Applicant: Samsung Electronics Co., Ltd., Gyeonggi-do (KR)

(72) Inventors: Junsu CHOI, Gyeonggi-do (KR); Chiho KIM, Gyeonggi-do (KR); Junghun LEE, Gyeonggi-do (KR)

(21) Appl. No.: 17/565,735

(22) Filed: Dec. 30, 2021

Related U.S. Application Data
(63) Continuation of application No. PCT/KR2020/008609, filed on Jul. 1, 2020.

(30) Foreign Application Priority Data
Jul. 1, 2019 (KR) 10-2019-0078755

(51) Int. Cl. G01S 13/04; G01S 13/86; H04N 5/232; G01S 7/295

(52) U.S. Cl. CPC G01S 13/04; G01S 7/295; H04N 5/23219; G01S 13/867

(57) ABSTRACT

According to certain embodiments, an electronic device comprises: a memory storing reference data for at least one object; a communication interface configured to perform beamforming; and a processor operatively connected with the memory, and the communication interface, wherein the processor is configured to, select at least one channel from a plurality of channels in a plurality of frequency bands, control the communication interface to transmit at least one signal including one orthogonal sequence of a plurality of orthogonal sequences, over the selected at least one channel, control the communication interface to receive at least one signal reflected by an object over the selected at least one channel, obtain data related to the object based on the transmitted at least one signal and the received at least one signal, and attempt to recognize the object using the data related to the object and the reference data for the at least one object.

### CROSS-REFERENCE TO RELATED APPLICATION(S)

This application is a Continuation of and based on and claims priority under 35 U.S.C. § 120 to PCT International Application No. PCT/KR2020/008609, which was filed on Jul. 1, 2020, and claims priority to Korean Patent Application No. 10-2019-0078755, filed on Jul. 1, 2019, in the Korean Intellectual Property Office, the disclosures of which are incorporated by reference herein their entirety.

### BACKGROUND

### 1. Field

Certain embodiments relate to an electronic device for recognizing an object and an operating method thereof.

### 2. Description of Related Art

Electronic devices (e.g., mobile terminals, smart phones, or wearable devices) may provide various functions. These functions can include voice and text using third generation (3G), 4G, or 5G, short range wireless communication, playing music or video, a camera, navigation, or object recognition.

The electronic device can use object recognition for perform user authentication. When performing object recognition, the electronic device recognizes an object using data obtained from a camera, or a sensor. However, there are security vulnerabilities that can occur.

An electronic device supporting an institute of electrical and electronics engineers (IEEE) 802.11ay system may recognize an object with high precision, by transmitting and receiving a several GHz in a millimeter frequency band (e.g., 60 GHz) signals that bounce off of the object. However, if other electronic devices transmit and receive signals for the object recognition in the same vicinity, object recognition performance is degraded due to interference. The above information is presented as background information only to assist with an understanding of the disclosure. No determination has been made, and no assertion is made, as to whether any of the above might be applicable as prior art with regard to the disclosure.

### SUMMARY

According to certain embodiments, an electronic device comprises: a memory storing reference data for at least one object; a communication interface configured to perform beamforming; and a processor operatively connected with the memory, and the communication interface, wherein the processor is configured to, select at least one channel from a plurality of channels in a plurality of frequency bands, control the communication interface to transmit at least one signal including one orthogonal sequence of a plurality of orthogonal sequences, over the selected at least one channel, control the communication interface to receive at least one signal reflected by an object over the selected at least one channel, obtain data related to the object based on the transmitted at least one signal and the received at least one signal, and attempt to recognize the object using the data related to the object and the reference data for the at least one object.

According to certain embodiments, a comprises: selecting at least one channel from a plurality of channels in a plurality of frequency bands; forming a beam transmitting at least one signal comprising one of a plurality of orthogonal sequences, over the selected at least one channel with a communication interface; receiving at least one signal reflected by an object over the selected at least one channel by the communication interface; obtaining data related to the object based on the transmitted at least one signal and the received at least one signal; and attempting recognizing the object using the data related to the object and reference data for the at least one object.

According to certain embodiments, a non-transitory computer-readable medium stores a plurality of instructions, wherein execution of the plurality of instructions by a processor causes the processor to perform a plurality of operations, the plurality of operations comprising: selecting at least one channel from a plurality of channels in a plurality of frequency bands; forming a beam transmitting at least one signal comprising one of a plurality of orthogonal sequences, over the selected at least one channel with a communication interface; receiving at least one signal reflected by an object over the selected at least one channel with the communication interface; obtaining data related to the object based on the transmitted at least one signal and the received at least one signal; and attempting recognizing the object using the data related to the object and reference data for the at least one object.

### BRIEF DESCRIPTION OF DRAWINGS

FIG. 1 is a block diagram illustrating an electronic device in a network environment according to certain embodiments.

FIG. 2 is a block diagram illustrating a data format of a signal for object recognition according to certain embodiments.

FIG. 3 is a block diagram illustrating a scheme for transmitting and receiving a signal for object recognition in an electronic device according to certain embodiments.

FIG. 4 is a flowchart for recognizing an object in an electronic device according to certain embodiments.

FIG. 5 is an exemplary diagram illustrating a combination of channels of a plurality of frequency bands and a plurality of sequences according to certain embodiments.

FIG. 6 is an exemplary diagram illustrating a scheme for collecting data required for object recognition by transmitting and receiving a signal for object recognition in an electronic device according to certain embodiments.

FIG. 7 is a flowchart for collecting reference data for object recognition in an electronic device according to certain embodiments.

FIG. 8 is an exemplary diagram for collecting reference data for object recognition by using a channel and sequence combination in an electronic device according to certain embodiments.

FIG. 9 is a flowchart for transmitting and receiving a signal using a selected channel and sequence combination in an electronic device according to certain embodiments.

FIG. 10 is an exemplary diagram for transmitting and receiving a signal using a selected channel and sequence combination in an electronic device according to certain embodiments.

FIG. 11 is a flowchart for selecting a channel and sequence combination based on whether interference occurs in an electronic device according to certain embodiments.

FIG. 12 is a flowchart for recognizing an object based on collected data by an electronic device according to certain embodiments.

FIG. 13 is an exemplary diagram for recognizing an object based on collected data in an electronic device according to certain embodiments.

FIG. 14 is a flowchart for recognizing an object based on collected data in an electronic device according to certain embodiments.

FIG. 15 is an exemplary diagram for recognizing an object based on collected data in an electronic device according to certain embodiments.

FIG. 16 is a flowchart for performing object recognition training using a neural network in an electronic device according to certain embodiments.

### DETAILED DESCRIPTION

According to certain embodiments, an electronic device may select at least one combination from combinations of channels of a plurality of frequency bands and a plurality of sequences having orthogonality, transmit and receive a signal using the at least one selected channel and sequence combination, and thus prevent object recognition rate degradation while reducing a probability that interference occurs due to millimeter-wave transmission and reception signals of other adjacent electronic devices.

Hereinafter, certain embodiments are described in detail with reference to the accompanying drawings. It should be understood that embodiments and terms used therein are not intended to limit the technique described in this document to a specific embodiment, and are to include various changes, equivalents, and/or replacements for a corresponding embodiment. With regard to descriptions of the drawings, similar reference numerals may be used for similar elements. Singular expressions may include plural expressions, unless the context clearly indicates otherwise.

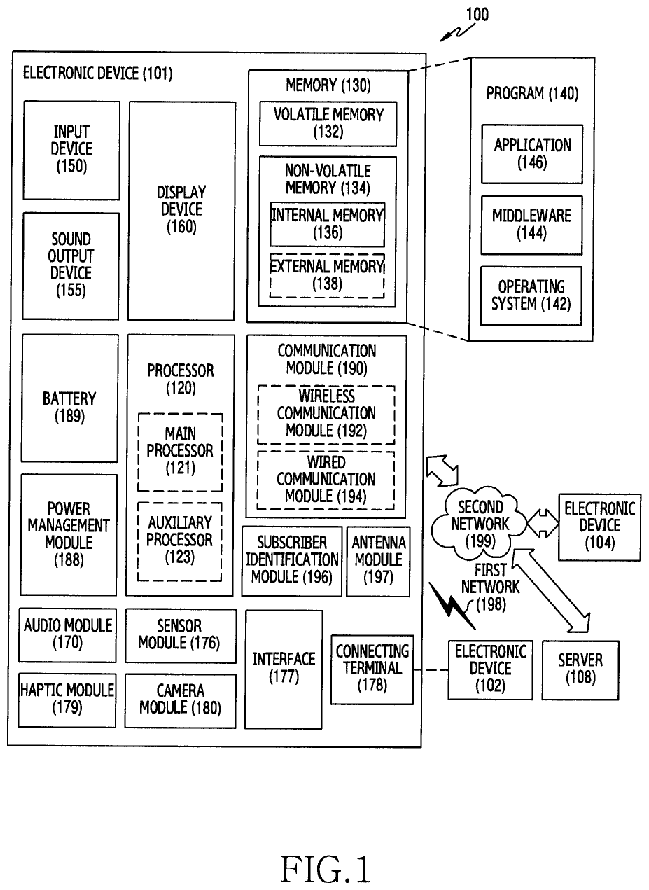

FIG. 1 describes an electronic device 100 where embodiments of the present disclosure can be practiced. The electronic device 100 can include sensitive data relating to the user, such as passwords, private emails, and financial instruments, to name just a few. It is therefore important for the device to authenticate the user before allowing access to the electronic device 100.

The electronic device 100 can authenticate the user by recognizing their face. The electronic device 100 can recognize the user's face by transmitting a wireless signal towards the user's face. The user's face reflects the wireless signal. Based on time of arrival, the electronic device 100 can ascertain a shape of the present user's face. The shape of the present user's face can be compared to an exemplar of the authorized user's face to authenticate the user.

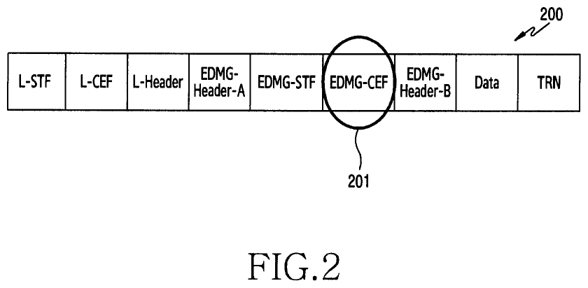

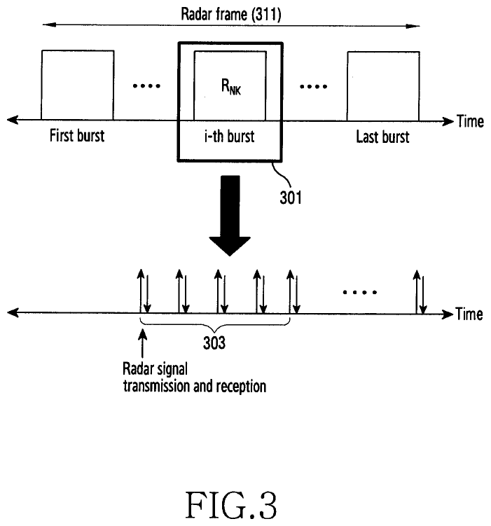

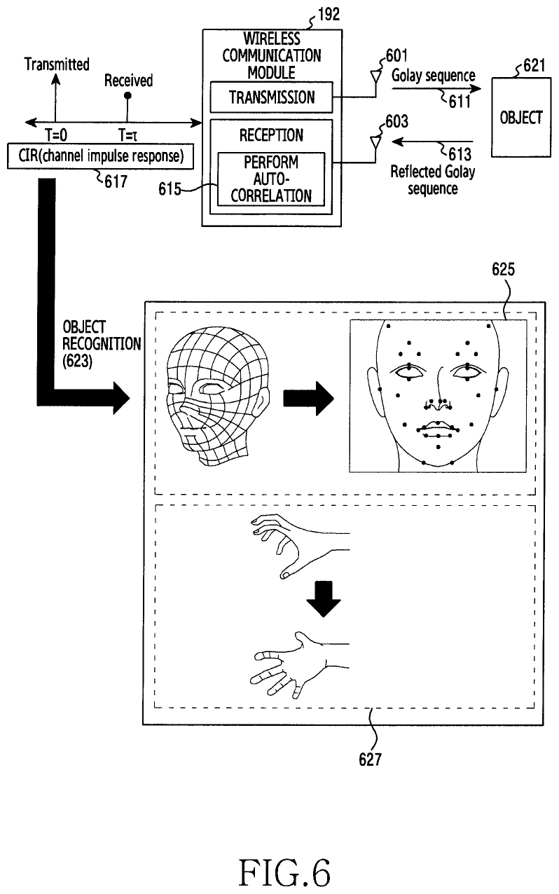

FIG. 1 is a block diagram illustrating an electronic device 101 in a network environment 100 according to certain embodiments. Hereinafter, operations of at least some components of FIG. 1 will be described with reference to FIGS. 2, 3, and 6. FIG. 2 is an exemplary diagram illustrating a data format of a signal for object recognition according to certain embodiments. FIG. 3 is an exemplary diagram illustrating a scheme for transmitting and receiving a signal for object recognition in an electronic device according to certain embodiments. FIG. 6 is an exemplary diagram illustrating a scheme for collecting data required for object recognition by transmitting and receiving a signal for object recognition in an electronic device according to certain embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module(SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The term “processor” shall be understood to refer to both the singular and plural contexts.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

As noted above, the electronic device 100 may include sensitive information related to the authorized user. Accordingly, it is important for the electronic device to verify that the present user is, in fact, the authorized user. To that end, the electronic device 100 transmits millimeter wave bands towards the present user's face. Based on the reflection, the electronic device 100 can ascertain the shape of the user's face and authenticate their identity.

The wireless communication module 192 may support a communication system of a millimeter wave band (e.g., a frequency band of about 60 GHz). For example, the wireless communication module 192 may support an institute of electrical and electronics engineers (IEEE) 802.11ad system or an IEEE 802.11ay system using a 60 GHz frequency band. The wireless communication module 192 may control at least a part of a first antenna (e.g., a first antenna 601 of FIG. 6) under the control of the processor 120, and thus transmit a signal including a designated sequence over at least one frequency channel in the millimeter wave band.

The designated sequence may be a sequence selected by the processor 120 from a plurality of sequences having orthogonality. For example, the designated sequence may be an N-th Golay sequence selected by the processor 120 among a plurality of Golay sequences having orthogonality. The Golay sequence has features that auto-correlation becomes a maximum value if a delay time is 0, and the auto-correlation becomes 0 or a value smaller than the maximum value if the delay time is not 0.

To determine the shape of the present user's face, wireless communication module 192 may obtain the delay time taken for the signal (including the designated Golay sequence) to be transmitted and then reflected and returned from an object. The delay time can be obtained by use of the auto-correlation feature of the Golay sequence. The signal including the designated sequence is a signal for object recognition, and may be, for example, a radar signal conforming to standard specifications of the IEEE 802.11ay system. The first antenna 601 may include an array antenna supporting beamforming.

The wireless communication module 192 may transmit the signal (including the designated sequence) over at least one frequency channel, using a data format conforming to the standard specifications of the IEEE 802.11ay system. For example, the wireless communication module 192 may transmit a signal configured in the format of a physical layer protocol data unit (PPDU) 200.

FIG. 2. is a block diagram illustrating a data format of a physical layer protocol data unit (PPDU) 200 for object recognition. The wireless communication module 192 may transmit the signal including the designated sequence in an enhanced directional multi-gigabit (EDMG)-channel estimation filed (CEF) 201 of the PPDU 200. The foregoing is provided by way of example and not limitation. The signal for the object recognition may be a signal of another format including the designated sequence.

Turning to FIG. 6, the present user's face (or object in question) 621 can be recognized by transmitting a Golay sequence 611 towards the object 621. The object 621 reflects the signal, resulting in a reflected Golay sequence 613. Based on the delay time between transmission of signal 611 and reception of signal 613, the distance of a point of the surface object 621 reflecting signal 613 can be determined. For example, distance can be the ½*delay time*c (where c is the speed of light). When the distance of enough points on the object 621 are determined, electronic device can determine the shape of the object 621. The shape of the object 621 can be used to, among other things, authenticate the identity of the user through facial recognition. In another example, the shape of the object 621 can be used to determine a hand gesture.

The wireless communication module 192 may control at least a part of the first antenna 601 or a second antenna 603 that may be logically and/or physically separated from the first antenna 601. The second antenna 602 may be under the control of the processor 120, and thus receive the signal including the designated sequence over at least one frequency channel in the millimeter wave band.

The received signal may be a reflection from an object of a signal transmitted from the wireless communication module 192. The object may include an object recognizable through a visual sense and/or a tactile sense, for example, a present user's face, or other physical object. The second antenna 603 may include an array antenna supporting the beamforming. The first antenna 601 and the second antenna 603 may be different antenna modules logically and/or physically separated, and may be one antenna module logically and/or physically integrated. The wireless communication module 192 may obtain object related data by performing the auto-correlation on the received signal. The object related data may be a data subset including a channel impulse response. The channel impulse response may include, for example, at least one of time delay information, phase information, angle of arrival (AoA) information, or angle of departure (AoD) of the received signal.

The wireless communication module 192 may repeatedly perform an operation of transmitting and receiving a signal including a designated sequence through each of a plurality of bursts included in one frame. The frame can be referred to as a radar frame.

Referring to FIG. 3, there is a block diagram of a radar frame 311 over a designated channel under the control of the processor 120. The wireless communication module 192 may repeatedly perform an operation of transmitting a signal R including a k-th sequence and receive a reflected signal having the k-th sequence in an i-th burst 301 over a designated channel N for a plurality of times during a designated time interval 303. The designated time interval 303 in which the operation of transmitting the signal R and receiving the reflected signal is performed, or the number of times may be changed under the control of the processor 120. For example, to recognize a user face or gesture, the wireless communication module 192 may repeatedly perform the operation of transmitting the signal R_{Nk} and receiving the reflected signal for a first designated number of times during a first designated time interval under the control of the processor 120.

As another example, to recognize a change of the gesture, the wireless communication module 192 may repeatedly perform the operation of transmitting the signal R and receiving the reflected signal for a second designated number of times during a second designated time interval under the control of the processor 120. The second designated time interval may be longer than the first designated time interval. The second designated number of times may be a value greater than the first designated number of times. The wireless communication module 192 may obtain object related data using signals transmitted and signals reflected and received during the designated time interval, and provide the obtained object related data to the processor 120. For example, the wireless communication module 192 may obtain channel impulse responses for the signals transmitted and the received signals reflected by the object during the designated time interval, and provide the obtained channel impulse responses to the processor 120.

The processor 120 may detect a reference data collecting event. A reference data collecting event can be for object recognition, to obtain reference data or an exemplar for the object. The reference data or exemplar can be stored in memory and can be considered reference data or an exemplar of a known object, or the authorized user's known face. During recognition, the shape of a user's face can be obtained and compared to the authorized user's known face to authenticate the user.

The processor 120 obtains reference data by transmitting and receiving signals for the object recognition. The reference data collecting event for the object recognition may include an event for registering object recognition information. For example, the event for registering the object recognition information may be an event for recognizing at least one of a user's face, a user's gesture, or an object shape and registering necessary reference data for the object recognition in the memory 130. For example, the processor 120 may execute an application which provides at least one function using the object recognition, and detect the event for registering the object recognition information through the executed application. The processor 120 may control the display device 160 to display a user interface requesting to input object identification information of an object to register, and receive from the user the object identification information (e.g., user ID, gesture ID or object ID) of the object to register.

To recognize and register an object corresponding to the inputted object identification information, the processor 120 may select at least one channel among a plurality of channels in a plurality of available frequency bands, and at least one sequence of a plurality of orthogonal sequences. The processor may control the wireless communication module 192 to transmit and receive signals R₁ₖ, R₂ₖ, R₃ₖ, . . . , R_{Nk} for the object recognition based on the selected combination of the at least one channel and the at least one orthogonal sequence. The processor 120 may receive the object related data of the object to register from the wireless communication module 192.

The processor 120 may obtain reference data for the object based on the object related data of the object to register, associate and store the reference data for the object and the object identification information. The processor 120 thus registers the object recognition information of the corresponding object. For example, the reference data for the object may include object related data obtained based on the combination of the selected at least one channel (from 1^{st} through N-th channels) and at least selected one sequence (from the 1^{st} through K-th sequences). For example, the reference data for the object may include object related data obtained by transmitting and receiving a signal including the K-th sequence over at least one channel selected from the first channel through the N-th channel. As another example, the reference data for the object may include object related data obtained by transmitting and receiving a signal including the K-th sequence over each of the first channel through the N-th channel. The foregoing is by way of example, and the reference data for the object according to other embodiments is limited thereto.

The processor 120 may perform learning (or training) for recognizing a corresponding object by inputting the object reference data of the object to register into a designated neural network. The neural network may be stored in an external device (e.g., the server 108 or another electronic device 102), or the electronic device 101. The neural network stored in the external device (e.g., the server 108, or the another electronic device 102) may be shared with the electronic device 101. The processor 120 may display on the display device 160 a recognition result of the corresponding object using the neural network, and determine whether the corresponding object is successfully recognized based on a user input. If determining that the corresponding object is successfully recognized based on the user input, the processor 120 may register the object recognition information of the corresponding object, by associating and storing the reference data used as the input of the neural network, output data of the neural network, and the object identification information.

The processor 120 may obtain a plurality of neural networks (or neural network models) for the plurality of the channels respectively by performing the neural network training on each of the plurality of the channels. For example, the processor 120 may generate a neural network model learned about the first channel by inputting the reference data of the object obtained from the first channel among the plurality of the channels into the designated neural network, generate a neural network model learned about the second channel by inputting the reference data of the object obtained from the second channel among the plurality of the channels into the designated neural network, and generate a neural network model learned about the N-th channel by inputting the reference data of the object obtained from the N-th channel among the plurality of the channels into the designated neural network. If generating the plurality of the neural network models with respect to the plurality of the channels, the processor 120 may register the object recognition information of the corresponding object for each neural network model.

The processor 120 may obtain one neural network (or neural network model) for all of the plurality of the channels, by performing the neural network training on all of the plurality of the channels. For example, the processor 120 may generate one neural network model for the plurality of the channels by inputting the reference data for the object obtained from the plurality of the channels into the designated neural network.

When detecting a designated event, the processor 120 may transmit and receive a signal for the object recognition. The designated event may include an event requesting the object recognition. The object recognition may include at least one of user's face recognition, user's gesture recognition, or object model recognition. For example, the processor 120 may execute an application which provides at least one function using the object recognition, and detect the event requesting the object recognition through the executed application. In response to detecting the event requesting the object recognition, the processor 120 may transmit and receive the signal for the object recognition by controlling the wireless communication module 192. The signal for the object recognition may be a signal including a designated sequence among a plurality of sequences having orthogonality.

When detecting a designated event, the processor 120 may select at least one channel among the plurality of the channels in the plurality of the available frequency bands in the millimeter wave band, and select at least one sequence of the plurality of the sequences having orthogonality. The processor 120 may control the wireless communication module 192 to transmit and receive signals for the object recognition while changing the channel and/or the sequence, based on a combination of the selected at least one channel and the selected at least one sequence.

The processor 120 may select one channel and one sequence, and control the wireless communication module 192 to transmit and receive signals for the object recognition including the one selected sequence over the one selected channel. For example, the processor 120 may select a first channel and a first sequence, and control the wireless communication module 192 to perform an operation of transmitting a signal R₁₁ including the first sequence over the first channel, and receiving a reflected signal including the first sequence. The processor 120 may select one channel and a plurality of sequences, and control the wireless communication module 192 to transmit and receive signals for the object recognition while changing the sequence in the one selected channel. For example, the processor 120 may select the first channel, the first sequence, and a third sequence, and control the wireless communication module 192 to transmit and receive a signal R₁₃ including the third sequence over the first channel, and to transmit and receive the signal R₁₁ including the first sequence over the first channel.

The processor 120 may select a plurality of channels and one sequence, and control the wireless communication module 192 to transmit and receive a signal including the one selected sequence while changing the channel. For example, the processor 120 may select the first channel, a fourth channel, and the first sequence, and control the wireless communication module 192 to transmit and receive a signal R₄₁ including the first sequence over the fourth channel, and to transmit and receive the signal R₁₁ including the first sequence over the first channel. According to an embodiment, the processor 120 may select a plurality of channels and a plurality of sequences, and control the wireless communication module 192 to transmit and receive a signal for the object recognition while changing the channel and the sequence based on combinations of the plurality of the channels and the plurality of the sequences. For example, the processor 120 may select the first channel and the third channel and a second sequence and a fifth sequence, and control the wireless communication module 192 to transmit and receive a signal R₁₂ including the second sequence over the first channel, to transmit and receiving a signal R₁₅ including the fifth sequence over the first channel, to transmit and receiving a signal R₃₅ including the fifth sequence over the third channel, and to transmit and receive a signal R₃₂ including the second sequence over the third channel.

It is noted that the accuracy of the objection recognition/facial recognition may be reduced by interference. For example, if there is another electronic device 100 transmitting millimeter wave band signals in the vicinity of the electronic device 100, the signals from the another electronic device 100 may interfere.

To avoid this, the processor 120 may select a plurality of channel and sequence combinations. The processor 120 may control the wireless communication module 192 to transmit and receive signals for the object recognition, while changing the channel and/or the sequence. The channel and sequence can be changed based on a selected channel and sequence combination.

For example, the processor 120 may select a 1^{st} channel and 4^{th} sequence combination, a 3^{rd} channel and 2^{nd} sequence combination, and a 2^{nd} channel and 5^{th} sequence combination. The processor 120 can then control the wireless communication module 192 to transmit and receive a signal R₁₄ (1^{st} channel and 4^{th} sequence), to transmit and receive a signal R₃₂ (3^{rd} channel and 2^{nd} sequence), and to transmit and receive a signal R₂₅ (2^{nd} channel and 5^{th} sequence). If it is necessary to change the channel and/or the sequence for the object recognition, the processor 120 may randomly change the channel and/or the sequence, and thus reduce a probability of using the same channel and/or sequence as another adjacent electronic device. Hence, the electronic device may reduce a probability that interference is caused by a signal transmitted from other adjacent electronic device.

The processor 120 may detect whether interference occurs based on a signal reception result. For example, based on at least one of whether an error occurs in the received signal, received signal strength indication (RSSI), or a signal-to-interference-plus-noise ratio (SINR), the processor 120 may detect whether interference by other adjacent electronic device occurs. If an error exists in the received signal, the RRSI is smaller than a designated value, or the SINR is greater than a designated value, the processor 120 may determine that the interference is caused by another adjacent electronic device. If determining that the interference occurs, the processor 120 may additionally select at least one channel and/or at least one sequence, and control the wireless communication module 192 to transmit and receive a signal for the object recognition while changing the channel and/or the sequence, based on a combination of the additionally selected channel and/or sequence.

The processor 120 may obtain object related data from the wireless communication module 192. The processor 120 can recognize at least one object based on the obtained data. The object related data may include a channel impulse response obtained based on a result of transmitting and receiving the signal for the object recognition through the wireless communication module 192. The channel impulse response may be obtained by performing the auto-correlation on the received signal. The processor 120 may obtain the object related data for each of at least one channel and sequence combination, and recognize the object based on the obtained object related data.

The processor 120 may recognize an object by comparing the object related data obtained for each of at least one channel and sequence combination with reference data prestored for each object. The processor 120 may determine similarity by comparing the obtained object related data with the prestored reference data per object. The processor 120 can deem the object to be the same as the object associated with the reference data based on whether the similarity is greater than a designated reference value. For example, the processor 120 may determine similarity “A” by comparing the obtained object related data for the combination of the 1^{st} channel and the 3^{rd} sequence with reference data for a first object (e.g., a first user, or a first gesture), determine similarity “B” by comparing the obtained object related data for the combination of the 2^{nd} and the 1^{st} sequence with the reference data for the first object, determine similarity “a” by comparing the obtained object related data for the combination of the 1^{st} channel and the 3^{rd} sequence with reference data for a second object (e.g., a second user, or a second gesture), and determine similarity “b” by comparing the obtained object related data for the combination of the 2^{nd} channel and the 1^{st} sequence with the reference data for the second object. If the similarity “B” has the greatest value among the similarities “A”, “B”, “a”, and “b” and the similarity “B” is greater than the designated reference value, the processor 120 may recognize that the corresponding object is the first object. If all of the similarities “A”, “B”, “a”, and “b” are smaller than the designated reference value, the processor 120 may determine that the object recognition fails.

In certain embodiments, the electronic device 100 can authenticate the user using another method, such as fingerprint recognition, password, among others, when object or facial recognition fails. If the user is successfully authenticated, the electronic device 100 may conclude that the object/facial recognition was in error. Moreover, the electronic device 100 can deem the error as likely caused by, or conclude altogether, that it was caused by interference.

The processor 120 may recognize an object by using object related data obtained for each of at least one channel and sequence combination as an input of a pre-learned neural network. The processor 120 may recognize the object based on output data of the pre-leamed neural network. The output data of the pre-learned neural network may include at least one of information indicating whether the recognized object exists (or whether the recognition is successful) among pre-registered objects, identification information of the corresponding object (e.g., user identification information, gesture identification information, object identification information), or reliability information.

The processor 120 may recognize the object based on the output data of the pre-learned neural network. The processor 120 may recognize the object based on the reliability included in the output data. For example, if the output data for the combination of the first channel and the second sequence is “recognized object: first object, reliability: “C””, the output data for the combination of the first channel and the fourth sequence is “recognized object: first object, reliability: “D””, the output data for the combination of the fourth channel and the fifth sequence is “recognized object: second object, reliability: “E””, and the output data for the combination of the second channel and the third sequence is “recognized object: none”, the processor 120 may select the reliability “C” having the highest value among the reliabilities “C”, “D”, and “E”, and recognize that the corresponding object is the first object corresponding to the reliability “C”.

If there is a plurality of neural networks (or a plurality of neural network models) pre-learned about a plurality of channels respectively, the processor 120 may select at least one neural network corresponding to at least one channel associated with the obtained object related data, and recognize an object using the selected at least one neural network. For example, there are N-ary neural networks pre-learned about N-ary channels respectively, and the object related data are obtained with respect to the combination of the first channel and the second sequence, the combination of the second channel and the fourth sequence, and the combination of the fourth channel and the first sequence, the processor 120 may select the first neural network pre-learned about the first channel, the second neural network pre-learned about the second channel, and the fourth neural network pre-learned about the fourth channel.

The processor 120 may input the object related data obtained for the combination of the first channel and the second sequence into the first neural network, input the object related data obtained for the combination of the second channel and the fourth sequence into the second neural network, input the object related data obtained for the combination of the fourth channel and the first sequence into the fourth neural network, and recognize the object based on the output data of the first neural network, the second neural network, and the fourth neural network. For example, the processor 120 may recognize the object based on the reliability included in the output data of each neural network.

If there is one neural network (or one neural network model) pre-learned about a plurality of channels, the processor 120 may recognize an object using one neural network. For example, if the object related data is obtained for the combination of the first channel and the second sequence, the combination of the second channel and the fourth sequence, and the combination of the fourth channel and the first sequence, the processor 120 may select one neural network. The processor 120 may recognize the object based on the output data for the combination of the first channel and the second sequence, the output data for the combination of the second channel and the fourth sequence, and the output data for the combination of the fourth channel and the first sequence using the one selected neural network. For example, the processor 120 may recognize the object based on the reliability included in each output data.

If the object recognition fails, the processor 120 may additionally select at least one channel and/or at least one sequence, and perform the operation for obtaining the object related data using the selected channel and/or sequence.

The processor 120 may provide an object recognition result through at least one of the display device 160, or the sound output device 155. For example, the processor 120 may provide the object recognition result including at least one of whether the object recognition is successful, recognized object identification information, and an image corresponding to the recognized object, through the running application.

In the above description, the IEEE 802.11ay system has been described as an example, but this is only an example for the sake of description, and the present disclosure shall not be limited thereto. For example, certain embodiments may be applied to other communication systems supporting the millimeter wave band.

An electronic device may include a memory (e.g., the memory 130 of FIG. 1) for storing reference data for at least one object, a communication interface (e.g., the wireless communication module 192 of FIG. 1) for performing beamforming, and a processor (e.g., the processor 120 of FIG. 1) operatively connected with the memory, and the communication interface, and the processor 120 may be configured to select at least one channel from a plurality of channels in a plurality of frequency bands, by controlling the communication interface, transmit at least one signal including one orthogonal sequence of a plurality of orthogonal sequences having orthogonality, over the selected at least one channel, by controlling the communication interface, receive at least one signal reflected by an object over the selected at least one channel, obtain data related to the object based on the transmitted at least one signal and the received at least one signal, and attempt to recognize the object using the data related to the object and the reference data for the at least one object.

According to certain embodiments, the data related to the object may include a channel impulse response.

According to certain embodiments, the processor 120 may obtain the data related to the object auto-correlating the received signal.

According to certain embodiments, the processor 120 may determine similarity of the object with to each of the at least one object by comparing the data related to the object and the reference data for each of the at least one object, and determine one object of the at least one obj ect as an object which reflects the signal, based on a similarity of the object to the one object.

According to certain embodiments, the processor 120 may detect a reference data collecting event, in response to detecting the collecting event, transmit and receive at least one signal including a designated orthogonal sequence among the plurality of the orthogonal sequences over each of the plurality of the channels, by controlling the communication interface, obtain a channel impulse response for each of combinations of the plurality of the channels and the designated orthogonal sequence, and store the channel impulse response for each of the combinations of the plurality of channels and the designated sequence as the reference data.

According to certain embodiments, the processor 120 may obtain object recognition information using a neural network which receives the reference data for the object as an input, provide the object recognition information through a user interface, determine whether object recognition is successful with respect to the object recognition information based on a user input, and if the object recognition success is determined, register the object recognition information as reference recognition information by mapping the object recognition information with identification information of the object.

According to certain embodiments, the processor 120 may obtain output data by inputting the data related to the object into the neural network, and attempt to recognize the object by comparing the obtained output data with the registered reference recognition information.

According to certain embodiments, the processor 102 may select at least one orthogonal sequence from the plurality of the sequences, determine a combination of the selected at least one channel and the selected at least one orthogonal sequence, and transmit the at least one signal while changing at least one of a channel for transmitting the at least one signal or a sequence to be included in the at least one signal, based on the determined combination.

According to certain embodiments, the processor 120 may be configured to determine whether interference occurs based on the received at least one signal, based on the determination, when the interference occurs, select a combination of another at least one channel and another orthogonal sequence, and recognize the object based on the selected combination by controlling the communication interface.

According to certain embodiments, the processor 120 may be configured to, when the recognition of the object fails, further select a combination of at least one other channel and another orthogonal sequence, and recognize the object based on the combination by controlling the communication interface.

According to certain embodiments, each of the plurality of the orthogonal sequences having the orthogonality may include a Golay sequence.

According to certain embodiments, an electronic device may include a communication interface (e.g., the wireless communication module 192 of FIG. 1) for performing beamforming, and a processor (e.g., the processor 120 of FIG. 1) operatively connected with the communication interface, and the processor may be configured to, by controlling the communication interface, transmit at least one signal including one of a plurality of sequences having orthogonality, over each of a plurality of channels in a plurality of frequency bands, by controlling the communication interface, receive at least one signal which is the at least one transmitted signal reflected and returning from an object, obtain data including a channel impulse response with respect to each of the plurality of the channels, based on the at least one transmitted signal and the at least one received signal, and performing training to recognize the object by inputting the obtained data into a designated neural network.

According to certain embodiments, the processor 120 may be configured to obtain a plurality of neural networks trained for the plurality of the channels respectively, or one neural network trained for the plurality of the channels, by inputting the data including the channel impulse response for each of the plurality of the channels into the designated neural network.

According to certain embodiments, the processor 120 may be configured to obtain object recognition information using the designated neural network, provide the object recognition result through a user interface, determine whether object recognition is successful with respect to the object recognition information, based on a user input, and if the object recognition success is determined, register the object recognition information as reference recognition information by mapping with identification information of the object.

According to certain embodiments, the processor 120 may be configured to, if detecting a designated event, select at least one channel from the plurality of the channels, transmit and receive at least one signal including one of the plurality of the sequences, over the selected at least one channel, by controlling the communication interface, obtain data including a channel impulse response for the at least one channel, based on the at least one transmit and received signal, input the obtained data into at least one neural network obtained by the training, and recognize the object based on output data of the at least one neural network model and the registered reference recognition information.

According to certain embodiments, the processor 120 may select at least one sequence from the plurality of the sequences, determine a combination of the selected at least one channel and the selected at least one sequence, and transmit and receive the at least one signal while changing at least one of a channel for transmitting the at least one signal, or a sequence to be included in the at least one signal, based on the determined combination.

According to certain embodiments, the processor 120 may be configured to determine whether interference occurs based on the at least one received signal, based on the determination, if interference occurs, additionally select at least one channel and sequence combination, and recognize the object based on the additionally selected channel and sequence combination by controlling the communication interface.

According to certain embodiments, the processor 120 may be configured to, if recognition of the object fails, additionally select at least one channel and sequence combination, and recognize the object based on the additionally selected channel and sequence combination by controlling the communication interface.

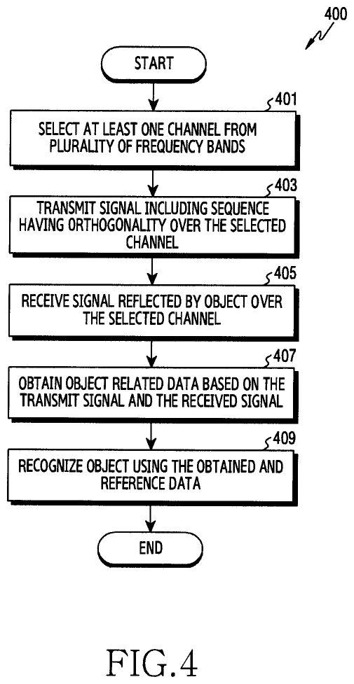

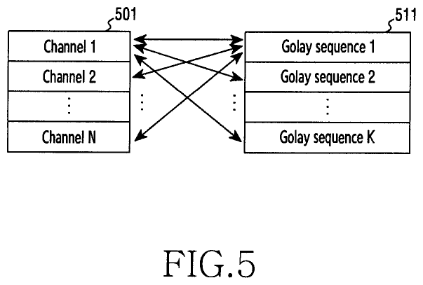

FIG. 4 is a flowchart 400 for recognizing an object in an electronic device according to certain embodiments. Operations may be sequentially performed in the following embodiment, but not necessarily in sequence. For example, the order of the operations may be changed, and at least two operations may be performed in parallel. Herein, the electronic device may be the electronic device 101 of FIG. 1. Hereafter, at least some operations of FIG. 4 shall be described with reference to FIG. 5 and FIG. 6.

FIG. 5 is an exemplary diagram illustrating combinations of channels of a plurality of frequency bands and a plurality of sequences according to certain embodiments. FIG. 6 is an exemplary diagram illustrating a scheme for collecting necessary data for object recognition by transmitting and receiving a signal for object recognition in an electronic device according to certain embodiments.

Referring to FIG. 4, according to certain embodiments, the electronic device (e.g., the processor 120 of FIG. 1) may select at least one channel from a plurality of frequency bands in operation 401. When a designated event is detected, the processor 120 may select at least one channel for transmitting a signal for the object recognition. The designated event may include, for example, an event for requesting the object recognition such as user face recognition, gesture recognition, or object model recognition. The processor 120 may detect execution of an application which provides at least one function using the object recognition, and detect the event requesting the object recognition through the executed application. The processor 120 may select at least one channel from the plurality of the channels in the plurality of the frequency bands available for the object recognition.

The processor 120 may additionally select at least one sequence from a plurality of sequences having orthogonality. The processor 120 may select at least one channel and sequence combination from the combinations of the plurality of the channels and the plurality of the sequences. For example, as shown in FIG. 5, if there are N-ary channels 501 in the plurality of the available frequency bands, and K-ary Golay sequences 511 having the orthogonality, N×K channel and sequence combinations in total may be generated. The processor 120 may select at least one combination from the N×K-ary channel and sequence combinations.

The electronic device (e.g., the processor 120, and/or the wireless communication module 192 of FIG. 1) may transmit a signal including one sequence from the plurality of the sequences having the orthogonality over the at least one selected channel in operation 403. According to an embodiment, the processor 120 may control the wireless communication module 192 to transmit and receive a signal for the object recognition while setting and/or changing the channel and/or the sequence, based on the combination of the at least one selected channel and at least one sequence. For example, if one channel and one sequence are selected, the processor 120 may control the wireless communication module 192 to transmit a signal for the object recognition including the selected sequence over the selected one channel. As another example, if one channel and a plurality of sequences are selected, the processor 120 may control the wireless communication module 192 to transmit a signal for the object recognition while changing the sequence in one selected channel. As yet another example, if a plurality of channels and one sequence are selected, the processor 120 may control the wireless communication module 192 to transmit a signal for the object recognition including the one selected sequence while changing the channel. As still another example, if a plurality of channels and a plurality of sequences are selected, the processor 120 may control the wireless communication module 192 to transmit a signal for the object recognition while changing the channel and/or the sequence based on combinations of the plurality of the channels and the plurality of the sequences. As further example, if a plurality of channel and sequence combinations is selected, the processor 120 may control the wireless communication module 192 to transmit a signal for the object recognition, while changing the channel and/or the sequence based on the selected channel and sequence combinations. If it is necessary to change the channel and/or the sequence for the object recognition, the processor 120 may arbitrarily change the channel and/or the sequence based on the selected at least one channel and at least one sequence. The electronic device may reduce a probability of using the same channel and/or sequence as other adjacent electronic device, and thus reduce a probability of interference caused by a signal transmitted from other adjacent electronic device.

The electronic device (e.g., the processor 120, and/or the wireless communication module 192) may receive a signal reflected by the object, over the at least one selected channel in operation 405. For example, by controlling the wireless communication module 192, the processor 120 may receive the signal transmitted from the electronic device 101 and then reflected by the object, over the same channel as the channel transmitting the signal for the object recognition. The object may include, for example, at least one of a user's face, a gesture, or a thing. The reflected signal may include the same sequence as the sequence included in the signal transmitted in operation 403. For example, as shown in FIG. 6, the wireless communication module 192 may transmit a signal 611 including a Golay sequence over the selected channel, and receive a signal 613 reflected by an object 621.

The electronic device (e.g., the processor 120, and/or the wireless communication module 192) may obtain object related data, based on the transmit signal and the received signal in operation 407. The wireless communication module 192 may obtain object related data of a corresponding object which reflects the signal, by performing the auto-correlation on the received signal, under the control of the processor 120. The object related data may include a channel impulse response. The channel impulse response may include, for example, at least one of time delay information, phase information, AoA information, or AoD of the received signal. The object related data may be obtained for each at least one channel and sequence combination. For example, the wireless communication module 192 may perform the auto-correlation 615 on the received signal, as shown in FIG. 6, and thus obtain a channel impulse response 617 of the corresponding object 621.

The electronic device (e.g., the processor 120) may recognize an object using the object related data and reference data for at least one object in operation 409. According to an embodiment, the processor 120 may recognize an object by comparing the object related data with reference data prestored per object. For example, the processor 120 may determine similarity by comparing the object related data with the prestored reference data per object, and recognize an object based on the similarity. According to an embodiment, the processor 120 may recognize an object by using the object related data as an input of a neural network. The neural network may be learned in advance by using the reference data for at least one object. For example, the processor 120 may input the object related data to the pre-learned neural network, and recognize an object based on output data of the pre-learned neural network. The output data of the pre-learned neural network may include at least one of information indicating whether a recognized object exists (or whether the recognition is successful) among pre-registered objects, identification information of the corresponding object (e.g., user identification information, gesture identification information, or object identification information), or reliability information. The processor 120 may recognize the object based on the reliability included in the output data. For example, the processor 120 may perform object recognition 623 by using the obtained channel impulse response 617 as shown in FIG. 6. For example, processor 120 may recognize 625 which user face is a user face of the corresponding object 621 among pre-registered user faces, or recognize a gesture among pre-registered gestures, or recognize 627 a change in gesture.

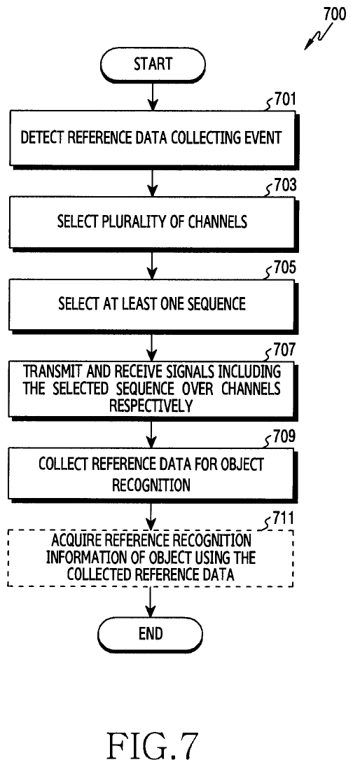

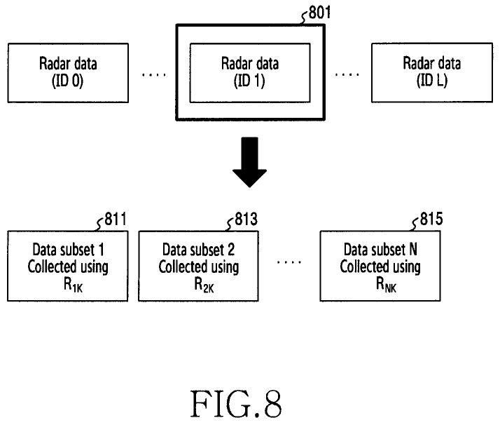

FIG. 7 is a flowchart 700 for collecting reference data for object recognition in an electronic device according to certain embodiments. Operations may be sequentially performed in the following embodiment, but not necessarily in sequence. For example, the order of the operations may be changed, and at least two operations may be performed in parallel. Operation marked with a dotted line may be omitted depending on the embodiment. Herein, the electronic device may be the electronic device 101 of FIG. 1. Hereafter, at least some operations of FIG. 7 shall be described with reference to FIG. 8. FIG. 8 is an exemplary diagram for collecting reference data for object recognition by using a channel and sequence combination in an electronic device according to certain embodiments.

Referring to FIG. 7, according to certain embodiments, the electronic device (e.g., the processor 120 of FIG. 1) may detect a reference data collecting event for the object recognition in operation 701. The reference data collecting event for the object recognition may include an event for registering object recognition information. For example, the event for registering the object recognition information may be an event for registering reference data required for the object recognition in a memory (e.g., the memory 130 of FIG. 1) by recognizing at least one of a user's face, a user's gesture, or a model of a thing. For example, the processor 120 may execute an application which provides at least one function using the object recognition, and detect the event for registering the object recognition information through the executed application. In certain embodiments, the reference data collecting event can be included in the initialization when the user purchases the electronic device.

If detecting the reference data collecting event for the object recognition, the processor 120 may control the display device 160 to display a user interface. The user interface (UI) can request input of object identification information of an object to register. In response the UI can receive from the user, such as the object identification information (e.g., a user ID, a gesture ID, or an object ID) of the object to register.

The electronic device (e.g., the processor 120) may select a plurality of channels in operation 703. For example, the processor 120 may select all channels within a plurality of available frequency bands. Selecting the plurality of the channels can improve the object recognition rate. For example, since the channel impulse response obtained for each channel is different, it is to obtain the channel impulse response for every possible channel. Herein, selecting all the channels in the plurality of the available frequency bands is by way of example, and certain not limitation. For example, it may be applied to selecting at least one channel in the same manner.

The electronic device (e.g., the processor 120) may select at least one orthogonal sequence in operation 705. For example, the processor 120 may select at least one orthogonal sequence from a plurality of orthogonal sequences.

The electronic device (e.g., the processor 120, and/or the wireless communication module 192 of FIG. 1) may transmit and receive signals including the one selected orthogonal sequence, over each of the plurality of the channels in operation 707. For example, the processor 120 may change the channel from the first channel to the N-th channel, and transmit the signal including the one selected orthogonal sequence over each channel. For example, if the selected channel is a first channel, a second channel, and a third channel, the processor 120 may transmit the signal including the one selected orthogonal sequence over the first channel, the second channel and the third channel. The processor 120 can change from the first channel to the second channel and the second channel to the third channel.

If a plurality of orthogonal sequences is selected, the operation of transmitting and receiving the signal including the corresponding sequence over each of the plurality of the channels may be performed, for each of the plurality of the sequences.

The electronic device (e.g., the processor 120, and/or the wireless communication module 192 of FIG. 1) may collect the reference data for the object recognition based on signal transmission and reception results in operation 709. The wireless communication module 192 may obtain object related data including a channel impulse response, by performing the auto-correlation on the received signal, based on the control of the processor 120. The processor 120 may obtain the object related data for each channel and sequence combination from the wireless communication module 192. The processor 120 may collect reference data for a corresponding object by using the object related data for each channel and sequence combination.

In certain embodiments, the reference data for an object can included data based on the received reflection from transmitting a particular sequence, e.g., the Kth sequence over each one of N channels.

In FIG. 8, reference data 801 of an object having object identification information “ID 1” may include N-ary data subsets 811, 813, and 815. The electronic device may store in memory, reference data for objects having identification “ID 0” . . . “ID L” (where L is an arbitrary positive integer). The data subsets 811, 813, and 815 can include object related data obtained by transmitting and receiving signals including a K-th sequence over each of a first channel through an N-th channel. The first data subset 811 may include the object related data obtained by transmitting and receiving a signal R_{1K} including the K-th sequence over the first channel. The second data subset 813 may include the object related data obtained by transmitting and receiving a signal R_{2K} including the K-th sequence over the second channel. The N-th data subset 815 may include the object related data obtained by transmitting and receiving a signal R_{NK} including the K-th sequence over the N-th channel. In the example of FIG. 8, it is disclosed that the reference data 801 of the object includes the data subsets obtained by transmitting and receiving the signals including the K-th sequence over each of the first channel through the N-th channel, by way of example, and not limitation. For example, the reference data of the object may include at least one data subset obtained by transmitting and receiving at least one other sequence (e.g., at least one of the first sequence through the K−1-th sequence) over at least one channel of the first channel through the N-th channel.

The electronic device (e.g., the processor 120) may obtain reference recognition information of the object using the collected reference data in operation 711. The processor 120 may obtain the reference recognition information by inputting the reference data collected for the corresponding object into a designated neural network. For example, the processor 120 may perform learning (or training) for recognizing the corresponding object by inputting the reference data collected for the corresponding object into the designated neural network.

The processor 120 may control to display a result of recognizing the corresponding object on the display device 160 using the neural network, and determine whether the corresponding object is successfully recognized based on a user input. If determining that the corresponding object is successfully recognized based on the user input, the processor 120 may obtain the object recognition information of the corresponding object, by associating and storing the reference data used as the input of the neural network, the output data of the neural network, and the object identification information.

For example, the processor 120 may register the reference data used as the input of the neural network, the output data of the neural network, and the object identification information, as the reference recognition information of the corresponding object. The output data of the neural network may include data indicating at least one of a shape or a characteristic of the object. The processor 120 may obtain a plurality of neural networks (or neural network models) for the plurality of the channels respectively by performing the neural network training for each of the plurality of the channels, using the object related data obtained based on the signals transmitted and received over the plurality of the channels respectively. The processor 120 may obtain one neural network (or neural network model) for all of the plurality of the channels, by performing the neural network training on all of the plurality of the channels, using the object related data obtained based on the signals transmitted and received over the plurality of the channels respectively. The processor 120 may control to display on the display device 160 the result of recognizing the corresponding object using the plurality of the neural networks for the plurality of the channels respectively, or one neural network for the plurality of the channels, and determine whether the corresponding object is successfully recognized based on the user input.

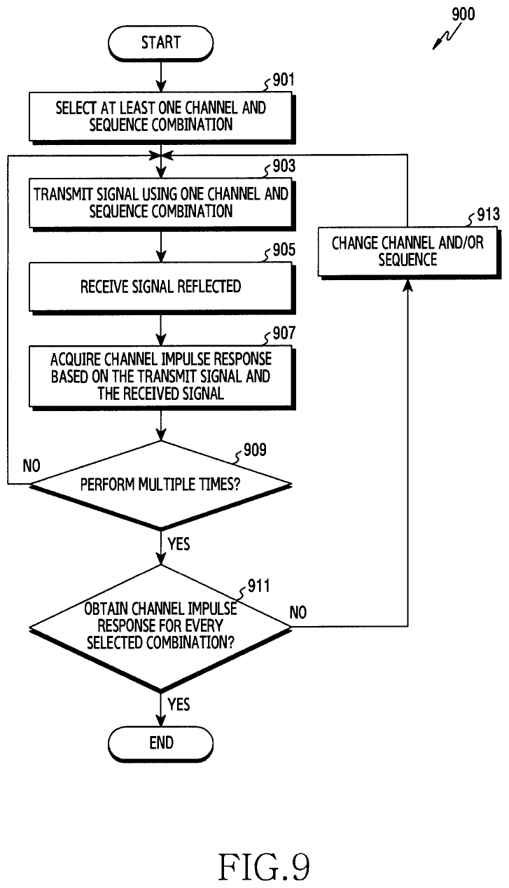

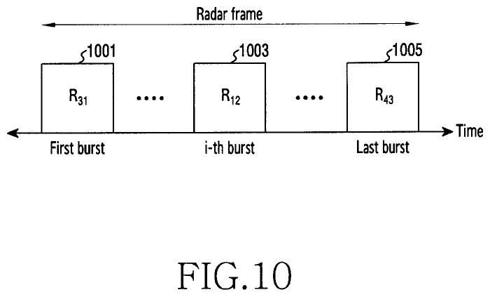

FIG. 9 is a flowchart 900 for transmitting and receiving a signal using a selected channel and sequence combination in an electronic device according to certain embodiments. Operations of FIG. 9 described below may be at least a part of detailed operations of operations 401 through 407 of FIG. 4. Operations may be sequentially performed in the following embodiment, but not necessarily in sequence. For example, the order of the operations may be changed, and at least two operations may be performed in parallel. Herein, the electronic device may be the electronic device 101 of FIG. 1. Hereafter, at least some operations of FIG. 9 shall be described with reference to FIG. 10. FIG. 10 is an exemplary diagram for transmitting and receiving a signal using a selected channel and sequence combination in an electronic device according to certain embodiments.

Referring to FIG. 9, according to certain embodiments, the electronic device (e.g., the processor 120 of FIG. 1) may select at least one channel and sequence combination in operation 901. According to an embodiment, the processor 120 may select at least one channel and sequence combination, based on a plurality of channels in a plurality of available frequency bands and a plurality of sequences having orthogonality. For example, if there are N-ary channels in the plurality of the available frequency bands and K-ary Golay sequences having orthogonality, N×K-ary channel and sequence combinations in total may be generated. The processor 120 may select at least one channel and sequence combination from the N×K-ary channel and sequence combinations.

The electronic device (e.g., the processor 120, and/or the wireless communication module 192 of FIG. 1) may transmit a signal using one channel and sequence combination among at least one selected channel and sequence combination in operation 903. According to an embodiment, the processor 120 may identify one channel and sequence combination among at least one selected channel and sequence combination, and transmit a signal based on the identified channel and combination, by controlling the wireless communication module 192.

The electronic device (e.g., the processor 120, and/or the wireless communication module 192) may receive a signal reflected by the object in operation 905. According to an embodiment, the processor 120 may receive a signal transmitted from the wireless communication module 192 of the electronic device 101 and then reflected by the object over the identified channel. The received signal may include the same sequence as the sequence included in the signal transmitted in operation 903.

The electronic device (e.g., the processor 120, and/or the wireless communication module 192) may obtain a channel impulse response based on the transmit signal and the received signal in operation 907. For example, the processor 120 may perform the auto-correlation on the received signal by controlling the wireless communication module 192, and thus obtain the channel impulse response of the identified channel and sequence among at least one selected channel and sequence combination.

The electronic device (e.g., the processor 120) may determine whether the operations of transmitting and receiving the signal using the identified channel and sequence combination and obtaining the channel impulse response have been performed multiple times in operation 909. According to an embodiment, the processor 120 may determine whether operation 903 through operation 907 are performed multiple times with respect to the identified channel and sequence combination. For example, to recognize a user's face or gesture, the processor 120 may determine whether the operation of transmitting and receiving the signal based on the identified channel and sequence combination is repeatedly conducted for a first designated number of times during a first designated time interval, and their channel impulse responses have been obtained. As another example, to recognize a change in gesture, the processor 120 may determine whether the operation of transmitting and receiving the signal based on the identified channel and sequence combination is repeatedly conducted for a second designated number of times during a second designated time interval, and their channel impulse responses have been obtained.

When the operations of transmitting and receiving the signal using the identified channel and sequence combination and obtaining the channel impulse response are not conducted multiple times, the electronic device (e.g., the processor 120) may pre-perform operation 903 through operation 907, without changing the channel and/or the sequence.

When the operations of transmitting and receiving the signal using the identified channel and sequence combination and obtaining the channel impulse response are performed multiple times, the electronic device (e.g., the processor 120) may determine whether the operations of transmitting and receiving the signal and obtaining the channel impulse response are conducted for every selected combination in operation 911. For example, the processor 120 may determine whether operation 903 through operation 909 are perform on every channel and sequence combination selected in operation 901.

When the operations of transmitting and receiving the signal and obtaining the channel impulse response are not performed on every selected combination, the electronic device (e.g., the processor 120) may change the channel and/or the sequence in operation 913, and perform operation 903 through operation 907 based on the changed channel and/or sequence. For example, if a plurality of channel and sequence combinations is selected in operation 901, and the operations of transmitting and receiving the signal and obtaining the channel impulse response are not performed on each channel and sequence combinations selected, the processor 120 may identify at least one channel and sequence combination on which the operations of transmitting and receiving the signal and obtaining the channel impulse response are not performed among the selected channel and sequence combinations. The processor 120 may change the channel and/or the sequence for the signal transmission and reception, based on the at least one channel and sequence combination on which the operations of transmitting and receiving the signal and obtaining the channel impulse response are not performed. For example, as shown in FIG. 10, the processor 120 may control the wireless communication module 192 to obtain a channel impulse response by transmitting and receiving a signal R₃₁ including a first sequence over a third channel for multiple times during a first burst interval 1001, to obtain a channel impulse response by transmitting and receiving a signal R₁₂ including a second sequence over a first channel for multiple times during an i-th burst interval 1003, and to obtain a channel impulse response by transmitting and receiving a signal R₄₃ including a third sequence over a fourth channel for multiple times during a last burst interval 1005. As such, by changing the channel and/or the sequence by randomly selecting one channel and sequence combination from the plurality of the channel and sequence combinations selected, the processor 120 may reduce a probability of using the same channel and/or sequence as other adjacent electronic device.

When interference occurs, different channels and sequence combinations can be transmitted and reflections received until a channel and sequence combination is found where interference is not detected. The channel impulse response for the combination where interference can be deemed data related to the object. For example, the data may include time of flight information at various points from the electronic device, which correspond to distances. The collection of distances can reveal a surface of the object.

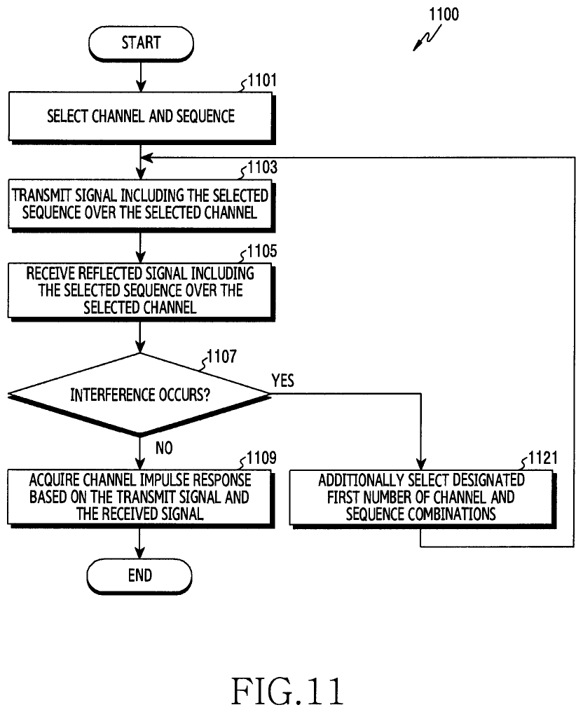

FIG. 11 is a flowchart 1100 for selecting a channel and sequence combination based on whether interference occurs in an electronic device according to certain embodiments. Operations of FIG. 9 described below may be at least a part of detailed operations of operations 401 through 407 of FIG. 4. Operations may be sequentially performed in the following embodiment, but not necessarily in sequence. For example, the order of the operations may be changed, and at least two operations may be performed in parallel. Herein, the electronic device may be the electronic device 101 of FIG. 1.

Referring to FIG. 11, according to certain embodiments, the electronic device (e.g., the processor 120 of FIG. 1) may select one frequency channel and sequence in operation 1101. According to an embodiment, the processor 120 may select one channel and sequence combination, based on a plurality of channels in a plurality of available frequency bands and a plurality of sequences having orthogonality.

The electronic device (e.g., the processor 120, and/or the wireless communication module 192 of FIG. 1) may transmit a signal including the selected sequence over the selected frequency channel in operation 1103, and receive a reflected signal including the selected sequence over the selected frequency channel in operation 1105. The received signal may include a signal transmitted from the wireless communication module 192 of the electronic device and reflected by an object.

The electronic device (e.g., the processor 120) may determine whether interference has occurred in 1107. For example, the processor 120 may detect whether interference by other adjacent electronic device has occurred, based on at least one of whether an error occurs in the received signal, RSSI, or SINR. If the received signal includes an error, the RRSI is smaller than a designated value, or the SINR is greater than a designated value, the processor 120 may determine that the interference by other adjacent electronic device occurs.

When no interference occurs, the electronic device (e.g., the processor 120) may obtain a channel impulse response based on the transmit signal and the received signal in 1109. For example, the processor 120 may obtain the channel impulse response, by performing the auto-correlation on the received signal.

When interference occurs, the electronic device (e.g., the processor 120) may additionally select a designated number of channel and sequence combinations in 1121, and perform operation 1103. For example, the processor 120 may additionally select at least one channel and sequence combination in addition to the channel and sequence combination selected in operation 1101. For example, the processor 120 may additionally select the designated number of channel and sequence combinations, to transmit and receive signals with no interference from other adjacent electronic devices.

An object can be recognized by comparing the object related to the object from FIG. 11 to reference data for each object. Where the collected object related data is less than a first designated reference value, the electronic device can deem that the object is not the object associated with the reference data. Where the collected object related data is between the first designated reference value and a second designated reference value, the identity of the object associated with the reference data, as well as the identity of other objects related to other reference data are provided when the obtained data is compared to the reference data for each object. Where the similarity exceeds a second designated reference value, the object is deemed to be the object associated with the reference data.

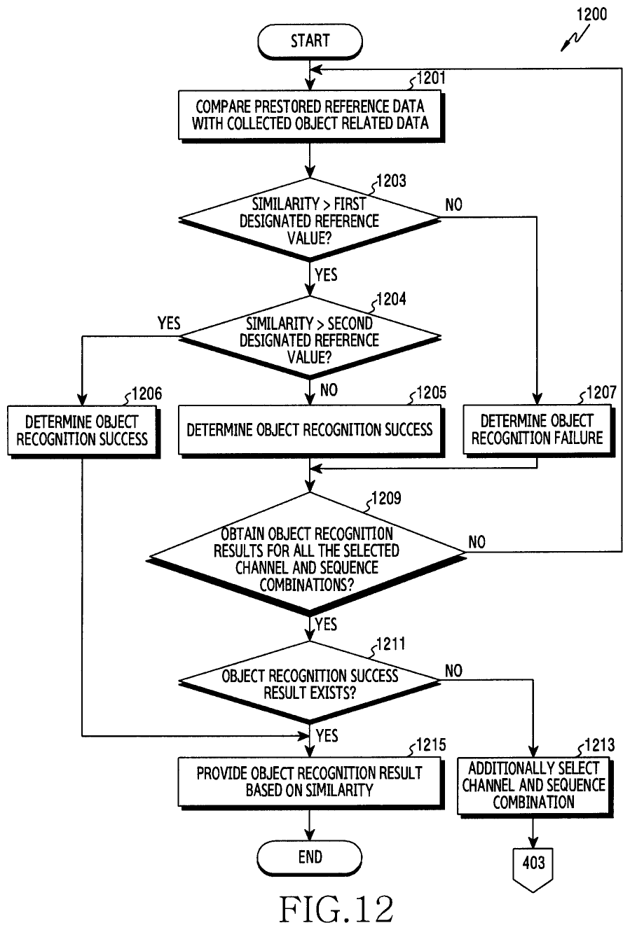

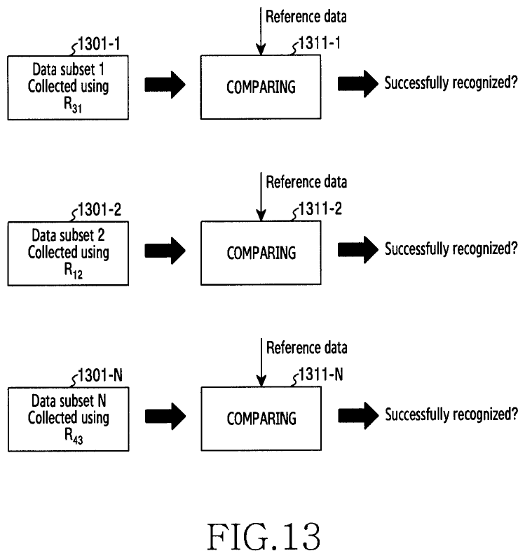

FIG. 12 is a flowchart 1200 for recognizing an object based on collected data in an electronic device according to certain embodiments. Operations of FIG. 12 described below may be an example of certain embodiments of operation 409 of FIG. 4. Operations may be sequentially performed in the following embodiment, but not necessarily in sequence. For example, the order of the operations may be changed, and at least two operations may be performed in parallel. Herein, the electronic device may be the electronic device 101 of FIG. 1. Hereafter, at least some operations of FIG. 12 will be described with reference to FIG. 13. FIG. 13 is an exemplary diagram for recognizing an object based on collected data in an electronic device according to certain embodiments.

Referring to FIG. 12, according to certain embodiments, the electronic device (e.g., the processor 120 of FIG. 1) may compare prestored reference data with collected object related data in operation 1201. According to an embodiment, the processor 120 may compare prestored reference data per object with object related data obtained using a selected channel and sequence combination, and thus identify reference data which is most similar to the obtained object related data. For example, as shown in FIG. 13, the processor 120 may compare 1311-1 a first data subset 1301-1 obtained using a first sequence in a third channel with the prestored reference data per object, and thus determine that the first data subset 1301-1 and the reference data of the first object are most similar among the prestored reference data per object. The processor 120 may obtain similarity of the first data subset 1301-1 and the reference data of the first object based on the comparison result.

The electronic device (e.g., the processor 120) may determine whether the similarity obtained by comparing the prestored reference data with the collected object related data is greater than a first designated reference value in operation 1203.

When the obtained similarity is greater than the first designated reference value, the electronic device (e.g., the processor 120) may determine whether the obtained similarity is greater than a second designated reference value in operation 1204. The second designated reference value may be a value greater than the first designated reference value.

When the obtained similarity is greater than the second designated reference value, the electronic device (e.g., the processor 120) may determine object recognition success in operation 1206, and provide the object recognition result based on the similarity in operation 1215. For example, if the obtained similarity is greater than the second designated reference value, the processor 120 may determine that there is no need to obtain the object recognition result of another channel and sequence combination and immediately proceed to operation 1215.

When the obtained similarity is greater than the first designated reference value and smaller than or equal to the second designated reference value, the electronic device (e.g., the processor 120) may determine that the object recognition is successful in operation 1205 and proceed to operation 1209. For example, if the similarity of the object related data obtained for the selected channel and sequence combination and the reference data of the first object is greater than the first designated reference value, the processor 120 may determine that the object of the corresponding reference data is recognized but it is necessary to obtain an object recognition result of another channel and sequence combination to obtain a more accurate object recognition result, and proceed to operation 1209.

When the obtained similarity is smaller than or equal to the first designated reference value, the electronic device (e.g., the processor 120) may determine that the object recognition fails in operation 1207. For example, the processor 120 may determine that the object recognition fails, if the similarity of the object related data obtained for the selected channel and sequence combination and the reference data of the first object is smaller than or equal to the designated reference value.

The electronic device (e.g., the processor 120) may determine whether object recognition results are obtained for all of the selected channel and sequence combinations in operation 1209.

When the object recognition results are not obtained for all of the selected channel and sequence combinations in operation 1209, the electronic device (e.g., the processor 120) may return to operation 1201, and compare object related data collected for the channel and sequence combination of which the object recognition result is not obtained with the prestored reference data.

When the object recognition results are obtained for all of the selected channel and sequence combinations, the electronic device (e.g., the processor 120) may determine whether there is an object recognition success result among the object recognition results of at least one channel and sequence combination in operation 1211. For example, if one channel and sequence combination is selected, the processor 120 may determine whether object recognition using the selected one channel and sequence combination is successful. As another example, if a plurality of channel and sequence combinations is selected, the processor 120 may determine whether object recognition of at least one channel and sequence combination among the selected channel and sequence combinations is successful.

When the object recognition success result exists, the electronic device (e.g., the processor 120) may provide the object recognition result based on the similarity in operation 1215. For example, the processor 120 may determine an object corresponding to the object recognition result of the highest similarity among the object recognition results determined as the object recognition success as a final object recognition result. For example, as shown in FIG. 13, an object recognition result having the highest similarity may be selected from an object recognition result obtained by comparing 1311-1 the first data subset 1301-1 and the prestored reference data per object, an object recognition result obtained by comparing 1311-2 a second data subset 1301-2 and the prestored reference data per object, and an object recognition result obtained by comparing 1311-N an N-th data subset 1301-N and the prestored reference data per object, and the selected object recognition result may be determined as the final object recognition result.

When there is no object recognition success result, the electronic device (e.g., the processor 120) may additionally select at least one channel and sequence combination in operation 1213, and perform operation 403 of FIG. 4.

Operation 1204 and operation 1206 of FIG. 12 may be omitted. If operation 1204 and operation 1206 of FIG. 12 are omitted, the electronic device (e.g., the processor 120) may perform the operation of obtaining the recognition results for all the selected channel and sequence combinations.

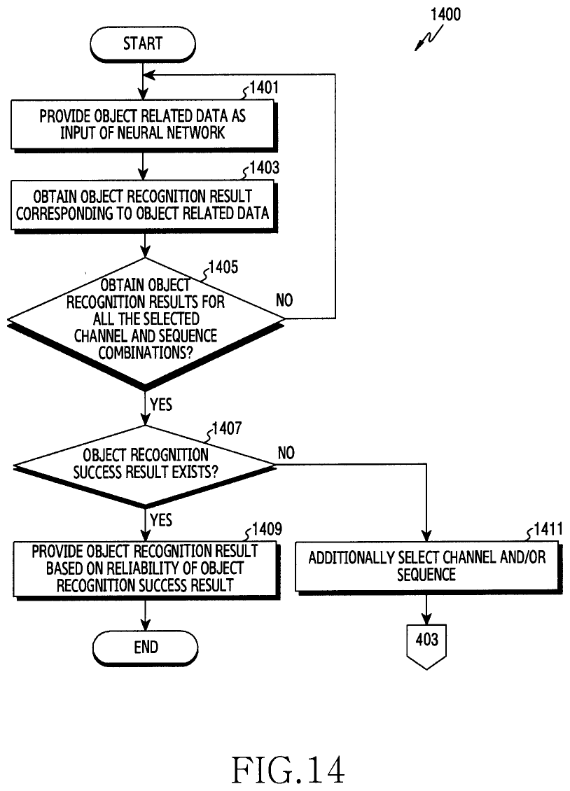

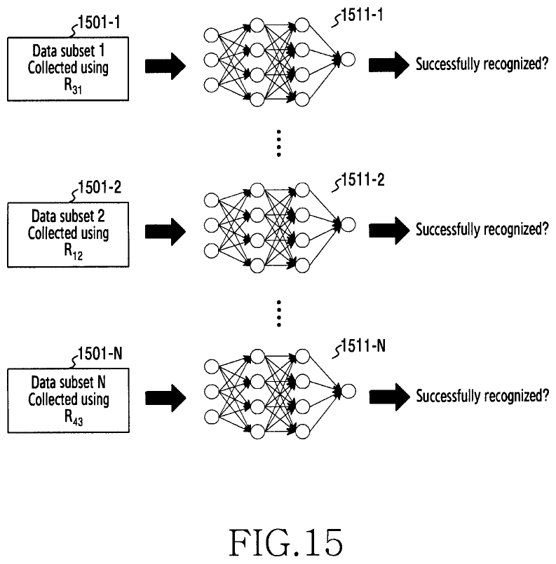

FIG. 14 is a flowchart 1400 for recognizing an object based on collected data in an electronic device according to certain embodiments. Operations of FIG. 14 described below may be an example of certain embodiments of operation 409 of FIG. 4. Operations may be sequentially performed in the following embodiment, but not necessarily in sequence. For example, the order of the operations may be changed, and at least two operations may be performed in parallel. Herein, the electronic device may be the electronic device 101 of FIG. 1. Hereafter, at least some operations of FIG. 14 will be described with reference to FIG. 15. FIG. 15 is an example diagram for recognizing an object based on collected data in an electronic device according to certain embodiments.

Referring to FIG. 14, according to certain embodiments, the electronic device (e.g., the processor 120 of FIG. 1) may provide the object related data as the input of the neural network in operation 1401. According to an embodiment, the processor 120 may provide the object related data obtained using the selected channel and sequence combination as the input of the pre-learned neural network. For example, as shown in FIG. 15, the processor 120 may provide a first data subset 1501-1 obtained using the first sequence in the third channel as an input of a pre-leamed neural network 1511-1. According to an embodiment, if there is a plurality of neural networks (or a plurality of neural network models) pre-leamed about a plurality of channels respectively, the processor 120 may select at least one neural network corresponding to at least one channel associated with the obtained object related data, and provide the object related data as the input to the selected at least one neural network. For example, with N-ary neural networks pre-leamed about N-ary channels respectively, if object related data are obtained with respect to the combination of the first channel and the second sequence, the combination of the second channel and the fourth sequence, and the combination of the fourth channel and the fourth channel, the processor 120 may select the first neural network pre-learned about the first channel, the second neural network pre-learned about the second channel, and the fourth neural network pre-learned about the fourth channel. The processor 120 may input the object related data obtained for the combination of the first channel and the second sequence into the first neural network, input the object related data obtained for the combination of the second channel and the fourth sequence into the second neural network, and input the object related data obtained for the combination of the fourth channel and the first sequence into the fourth neural network. According to an embodiment, if there is one neural network (or one neural network model) pre-learned about a plurality of channels, the processor 120 may input object related data obtained for the selected channel and sequence combination, into one neural network.

The electronic device (e.g., the processor 120) may obtain an object recognition result corresponding to the object related data in operation 1403. According to an embodiment, the processor 120 may obtain an object recognition result corresponding to the object related data obtained using the selected channel and sequence combination, from at least one pre-learned neural network. For example, the processor 120 may obtain output data of at least one pre-learned neural network, as the object recognition result of the selected channel and sequence combination. The output data may include at least one of information indicating whether there is a recognized object (or whether the recognition is successful) among pre-registered objects, identification information of the corresponding object (e.g., user identification information, gesture identification information, object identification information), or reliability information. According to an embodiment, the identification information of the corresponding object may be obtained by comparing at least part of the output data of the neural network with reference recognition information pre-registered. According to an embodiment, the output data of the neural network may additionally include data indicating at least one of a shape or a characteristic of the object which reflects the signal. According to certain embodiments, the electronic device (e.g., the processor 120) may determine whether object recognition results are obtained with respect to all of the selected channel and sequence combinations in operation 1405.

When object recognition results of all the selected channel and sequence combinations are not obtained, the electronic device (e.g., the processor 120) may return to operation 1401, and provide a channel impulse response of the channel and sequence combination of which the object recognition result is not obtained as the input of the neural network. For example, as shown in FIG. 15, the processor 120 may provide a second data subset 1501-2 obtained using the second sequence in the first channel as an input of a pre-learned neural network 1511-2, and provide an N-th data subset 1501-N obtained using the third sequence in the fourth channel as an input of a pre-learned neural network 1511-N.

Pre-learned neural networks 1511-1 through 1511-N, shown in FIG. 15, may be different from each other, or may be the same. For example, the pre-learned neural networks 1511-1 through 1511-N may be different neural network models which are separately learned about a plurality of channels respectively and configured at least in part differently. As another example, the pre-learned neural networks 1511-1 through 1511-N may be the same neural network models learned about a plurality of channels respectively.

When the object recognition results are obtained for all of the selected channel and sequence combinations, the electronic device (e.g., the processor 120) may determine whether there is an object recognition success result among the object recognition results of all the selected channel and sequence combinations in operation 1407. For example, if one channel and sequence combination is selected, the processor 120 may determine whether object recognition using the selected one channel and sequence combination is successful. As another example, if a plurality of channel and sequence combinations is selected, the processor 120 may determine whether object recognition of at least one channel and sequence combination among the selected channel and sequence combinations is successful.

When the object recognition success result exists, the electronic device (e.g., the processor 120) may provide the object recognition result based on reliability included in the object recognition success result in operation 1409. For example, the processor 120 may determine an object corresponding to the object recognition result of the highest reliability among the object recognition results determined as the object recognition success as a final object recognition result. For example, as shown in FIG. 15, reliability of the output data obtained by providing the first data subset 1501-1 as the input of the neural network 1511-1, reliability of the output data obtained by providing the second data subset 1501-2 as the input of the neural network 1511-2, and reliability of the output data obtained by providing the N-th data subset 1501-N as the input of the neural network 1511-N each may be identified, and the output data of the highest reliability may be selected as the final object recognition result. The processor 120 may provide the final object recognition result to the user by controlling at least one of the display (e.g., the display device 160 of FIG. 1), or the sound output device (e.g., the sound output device 155 of FIG. 1).

According to certain embodiments, if there is no object recognition success result, the electronic device (e.g., the processor 120) may additionally select at least one channel and sequence combination in operation 1411, and perform operation 403 of FIG. 4.

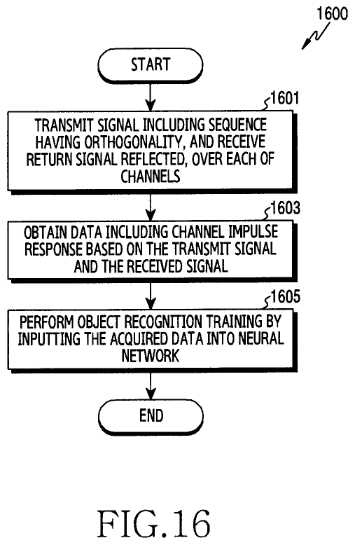

FIG. 16 is a flowchart 1600 for performing object recognition training using a neural network in an electronic device according to certain embodiments. Operations may be sequentially performed in the following embodiment, but not necessarily in sequence. For example, the order of the operations may be changed, and at least two operations may be performed in parallel. Herein, the electronic device may be the electronic device 101 of FIG. 1.

Referring to FIG. 16, according to certain embodiments, the electronic device (e.g., the processor 120 of FIG. 1, and/or the wireless communication module 192 of FIG. 1) may transmit at least one signal including one of a plurality of sequences having orthogonality, over each of a plurality of frequency bands in a plurality of frequency bands, and receive at least one signal which is the at least one transmit signal reflected and returned by an object in operation 1601. According to an embodiment, operation 1601 may include at least part of operation 701, operation 703, operation 705, and operation 707 of FIG. 7.

According to certain embodiments, the electronic device (e.g., the processor 120, and/or the wireless communication module 192) may obtain data including a channel impulse response, based on the transmit signal and the received signal in operation 1603. According to an embodiment, the wireless communication module 192 may obtain object related data including the channel impulse response, by performing the auto-correlation on the received signal, under the control of the processor 120. According to an embodiment, operation 1603 may include at least part of operation 709.

According to certain embodiments, the electronic device (e.g., the processor 120) may perform the object recognition training by inputting the obtained data including the channel impulse response into the neural network in operation 1605. The neural network may be stored in an external device (e.g., the server 108, or the other electronic device 102), or the electronic device 101. The neural network stored in the external device (e.g., the server 108, or the other electronic device 102) may be shared with the electronic device 101. According to an embodiment, operation 1605 may include at least part of operation 711. According to an embodiment, the processor 120 may obtain a plurality of neural networks (or neural network models) for the plurality of the channels respectively by performing the neural network training on each of the plurality of the channels. For example, the processor 120 may generate the neural network model learned about the first channel by inputting reference data for the object obtained from the first channel of the plurality of the channels into the designated neural network, generate the neural network model learned about the second channel by inputting reference data for the object obtained from the second channel of the plurality of the channels into the designated neural network, and generate the neural network model learned about the N-th channel by inputting reference data for the object obtained from the N-th channel of the plurality of the channels into the designated neural network. According to an embodiment, the processor 120 may obtain one neural network (or neural network model) for all of the plurality of the channels, by performing the neural network training on all of the plurality of the channels. For example, the processor 120 may generate one neural network model for the plurality of the channels by inputting the reference data for the object obtained in the plurality of the channels into the designated neural network.

According to certain embodiments, an operating method of an electronic device 101 may include selecting at least one channel from a plurality of channels in a plurality of frequency bands, by controlling forming a beam transmitting at least one signal comprising one of a plurality of orthogonal sequences over the selected at least one channel with a communication interface (e.g., the wireless communication module 192 of FIG. 1), receiving at least one signal reflected by an object over the selected at least one channel by the communication interface, obtaining data related to the object based on the transmitted at least one signal and the received at least one signal, and attempting recognizing the object using the data related to the object and reference data for the at least one object. According to certain embodiments, obtaining the data related to the object further comprises: auto-correlating the received signal, thereby obtaining the data related to the object; and wherein the data related to the object comprises a channel impulse response.

According to certain embodiments, the data related to the object may include a channel impulse response.

According to certain embodiments, the data related to the object may be obtained by performing auto-correlation on the received signal.

According to certain embodiments, recognizing the object using the data related to the object and the reference data for the at least one object may include determining a similarity of the object to each one of the at least one object by comparing the data related to the object and the reference data for each one of the at least one object, and determining one object of the at least one object as an object which reflects the signal, based on a similarity of the object to the one object.

According to certain embodiments, the method of the electronic device may further include detecting a reference data collecting event, in response to detecting the collecting event, transmitting and receiving at least one signal including a designated orthogonal sequence among the plurality of the orthogonal sequences over each of the plurality of the channels, obtaining a channel impulse response for each combination of the plurality of the channels and the designated orthogonal sequence, and storing the channel impulse response for each one of the combinations of the plurality of the channels and the designated sequence as the reference data.

According to certain embodiments, a non-transitory computer-readable medium storing a plurality of instructions, wherein execution of the plurality of instructions by a processor causes the processor to perform a plurality of operations, the plurality of operations comprising: selecting at least one channel from a plurality of channels in a plurality of frequency bands; forming a beam transmitting at least one signal comprising one of a plurality of orthogonal sequences, over the selected at least one channel with a communication interface; receiving at least one signal reflected by an object over the selected at least one channel with the communication interface; obtaining data related to the object based on the transmitted at least one signal and the received at least one signal; and attempting recognizing the object using the data related to the object and reference data for the at least one object.

According to certain embodiments, obtaining the data related to the object further comprises: auto-correlating the received signal, thereby obtaining the data related to the object; and wherein the data related to the object comprises a channel impulse response.

According to certain embodiments, determining a similarity of the object to each one of the at least one object by comparing the data related to the object and the reference data for each one of the at least one object; and determining one object of the at least one object as an object which reflects the signal, based on the similarity of the object to the one object.

According to certain embodiments, the plurality of operations further comprise: determining whether interference occurs based on the received at least one signal, based on the determination, that the interference occurs, selecting a combination of another at least one channel and another orthogonal sequence, and recognizing the object based on the selected combination by controlling the communication interface.

According to certain embodiments, the plurality of operations further comprise: when recognition of the object fails, selecting a combination of at least one other channel and another orthogonal sequence, and recognizing the object based on the combination by controlling the communication interface.

According to certain embodiments, the operating method of the electronic device may further include obtaining object recognition information using a neural network which receives reference data for the object as an input, providing the object recognition information through a user interface, determining whether object recognition is successful with respect to the object recognition information based on a user input, and if the object recognition success is determined, registering the object recognition information as reference recognition information by mapping with identification information of the object. According to certain embodiments, recognizing the object using the data related to the object and the reference data for the at least one object may include obtaining output data by inputting the data related to the object into the neural network, and recognizing the object by comparing the obtained output data with the registered reference recognition information.

According to certain embodiments, transmitting at least one signal including one of a plurality of sequences having orthogonality, over the selected at least one channel, may include selecting at least one sequence from the plurality of the sequences, determining a combination of the selected at least one channel and the selected at least one sequence, and transmitting the at least one signal while changing at least one of a channel for transmitting the at least one signal or a sequence to be included in the at least one signal, based on the determined combination.

According to certain embodiments, determining whether interference occurs based on the received at least one signal may further include, if the interference occurs based on the determination, additionally selecting at least one channel and sequence combination, additionally obtaining data related to the object using the additionally selected channel and sequence combination by controlling the communication interface, and recognizing the object using the additionally obtained data related to the object.

According to certain embodiments, the plurality of the sequences having the orthogonality may include a Golay sequence.

According to certain embodiments, an operating method of an electronic device 101 may include transmitting and receiving at least one signal including one of a plurality of sequences having orthogonality, over each of a plurality of channels in a plurality of frequency bands, the at least one received signal being a signal which is the at least one signal transmitted and then reflected and returning from an object, obtaining data including a channel impulse response with respect to each of the plurality of the channels, based on the at least one transmitted signal and the at least one received signal, and performing training to recognize the object by inputting the obtained data into a designated neural network.

According to certain embodiments, performing the training may include obtaining a plurality of neural networks trained for the plurality of the channels respectively, or one neural network trained for the plurality of the channels.

According to certain embodiments, performing the training to recognize the object may include obtaining object recognition information using the designated neural network, providing the object recognition result through a user interface, determining whether object recognition is successful with respect to the object recognition information, based on a user input, and if the object recognition success is determined, registering the object recognition information as reference recognition information by mapping with identification information of the object.

According to certain embodiments, the operating method of the electronic device may further include, if detecting a designated event, selecting at least one channel from the plurality of the channels, transmitting and receiving at least one signal including one of the plurality of the sequences, over the selected at least one channel, by controlling the communication interface, obtaining data including a channel impulse response for the at least one channel, based on the at least one transmit and received signal, inputting the obtained data into at least one neural network obtained by the training, and recognizing the object based on output data of the at least one neural network model and the registered reference recognition information.

According to certain embodiments, transmitting and receiving the at least one signal including one of the plurality of the sequences, over the selected at least one channel may include selecting at least one sequence from the plurality of the sequences, determining a combination of the selected at least one channel and the selected at least one sequence, and transmitting and receiving the at least one signal while changing at least one of a channel for transmitting the at least one signal, or a sequence to be included in the at least one signal, based on the determined combination.

According to certain embodiments, it may further include determining whether interference occurs based on the at least one received signal, based on the determination, if interference occurs, additionally selecting at least one channel and sequence combination, and recognizing the object based on the additionally selected channel and sequence combination by controlling the communication interface.

According to certain embodiments, it may further include, if recognition of the object fails, additionally selecting at least one channel and sequence combination, and recognizing the object based on the additionally selected channel and sequence combination by controlling the communication interface.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor(e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a memory storing reference data for at least one object;
a communication interface configured to perform beamforming; and
a processor operatively connected with the memory, and the communication interface, wherein the processor is configured to,
select at least one channel from a plurality of channels in a plurality of frequency bands,
control the communication interface to transmit at least one signal including one orthogonal sequence of a plurality of orthogonal sequences, over the selected at least one channel,
control the communication interface to receive at least one signal reflected by an object over the selected at least one channel,
obtain data related to the object based on the transmitted at least one signal and the received at least one signal, and
attempt to recognize the object using the data related to the object and the reference data for the at least one object.

2. The electronic device of claim 1, wherein the data related to the object comprises a channel impulse response.

3. The electronic device of claim 1, wherein the processor is configured to obtain the data related to the object by auto-correlating the received signal.

4. The electronic device of claim 1, wherein the processor is configured to:
determine similarity of the object to each of the at least one object by comparing the data related to the object and the reference data for each of the at least one object, and
determine one object of the at least one object as an object which reflects the signal, based on a similarity of the object to the one object.

5. The electronic device of claim 1, wherein the processor is configured to:
detect a reference data collecting event,
in response to detecting the collecting event, control the communication interface to transmit and receive at least one signal comprising a designated orthogonal sequence among the plurality of the orthogonal sequences over each of the plurality of the channels,
obtain a channel impulse response for each combination of the plurality of the channels and the designated orthogonal sequence, and
stores the channel impulse response for each one of the combinations of the plurality of channels and the designated sequence as the reference data.

6. The electronic device of claim 4, wherein the processor is configured to:
obtain object recognition information using a neural network which receives the reference data for the object as an input,
provide the object recognition information through a user interface,
determine whether object recognition is successful with respect to the object recognition information based on a user input, and
in response to the object recognition success being determined, register the object recognition information as reference recognition information by mapping the object recognition information with identification information of the object.

7. The electronic device of claim 6, wherein the processor is configured to:
obtain output data by inputting the data related to the object into the neural network, and
attempting to recognize the object by comparing the obtained output data with the registered reference recognition information.

8. The electronic device of claim 1, wherein the processor is configured to,
select at least one orthogonal sequence from the plurality of the orthogonal sequences,
determine a combination of the selected at least one channel and the selected at least one orthogonal sequence, and
transmit the at least one signal while changing at least one of a channel for transmitting the at least one signal, based on the determined combination.

9. The electronic device of claim 1, wherein the processor is configured to,
determine whether interference occurs based on the received at least one signal,
based on the determination, when the interference occurs, select a combination of another at least one channel and another orthogonal sequence, and
recognize the object based on the selected combination by controlling the communication interface.

10. The electronic device of claim 1, wherein the processor is configured to,
when recognition of the object fails, further select a combination of at least one other channel and another orthogonal sequence, and
recognize the object based on the combination by controlling the communication interface.

11. The electronic device of claim 1, wherein the each of the plurality of the orthogonal sequences comprises a Golay sequence.

12. An operating method of an electronic device, comprising:
selecting at least one channel from a plurality of channels in a plurality of frequency bands;
forming a beam transmitting at least one signal comprising one of a plurality of orthogonal sequences, over the selected at least one channel with a communication interface;
receiving at least one signal reflected by an object over the selected at least one channel by the communication interface;
obtaining data related to the object based on the transmitted at least one signal and the received at least one signal; and
attempting recognizing the object using the data related to the object and reference data for the at least one object.

13. The method of claim 12, wherein obtaining the data related to the object further comprises:
auto-correlating the received signal, thereby obtaining the data related to the object; and
wherein the data related to the object comprises a channel impulse response.

14. The method of claim 12, further comprising:
determining a similarity of the object to each one of the at least one object by comparing the data related to the object and the reference data for each one of the at least one object; and
determining one object of the at least one object as an object which reflects the signal, based on a similarity of the object to the one object.

15. The method of claim 12, further comprising:
detecting a reference data collecting event;
in response to detecting the collecting event, transmitting and receiving at least one signal comprising a designated orthogonal sequence among the plurality of the orthogonal sequences over each of the plurality of the channels;
obtaining a channel impulse response for each combination of the plurality of the channels and the designated orthogonal sequence,; and
storing the channel impulse response for each one of the combinations of the plurality of the channels and the designated sequence as the reference data.

16. A non-transitory computer-readable medium storing a plurality of instructions, wherein execution of the plurality of instructions by a processor causes the processor to perform a plurality of operations, the plurality of operations comprising:
selecting at least one channel from a plurality of channels in a plurality of frequency bands;
forming a beam transmitting at least one signal comprising one of a plurality of orthogonal sequences, over the selected at least one channel with a communication interface;
receiving at least one signal reflected by an object over the selected at least one channel with the communication interface;
obtaining data related to the object based on the transmitted at least one signal and the received at least one signal; and
attempting recognizing the object using the data related to the object and reference data for the at least one object.

17. The non-transitory computer-readable medium of claim 16, wherein obtaining the data related to the object further comprises:
auto-correlating the received signal, thereby obtaining the data related to the object; and
wherein the data related to the object comprises a channel impulse response.

18. The non-transitory computer-readable medium of claim 16, wherein the plurality of operations further comprise:
determining a similarity of the object to each one of the at least one object by comparing the data related to the object and the reference data for each one of the at least one object; and
determining one object of the at least one object as an object which reflects the signal, based on the similarity of the object to the one object.

19. The non-transitory computer-readable medium of claim 16, wherein the plurality of operations further comprise:
determining whether interference occurs based on the received at least one signal,
based on the determination, that the interference occurs, selecting a combination of another at least one channel and another orthogonal sequence, and
recognizing the object based on the selected combination by controlling the communication interface.

20. The non-transitory computer-readable medium of claim 16, wherein the plurality of operations further comprise:
when recognition of the object fails, selecting a combination of at least one other channel and another orthogonal sequence, and
recognizing the object based on the combination by controlling the communication interface.
